(19) United States
(12) Patent Application Publication
(10) Pub. No.: US 2013/0283189 A1
(43) Pub. Date: Oct. 24, 2013

(54) SYSTEM AND METHOD FOR EFFICEINT EXCHANGE OF CONTENT WHILE REMAINING DEVICE AGNOSTIC

(71) Applicant: SYSTEMWARE, INC., Addison, TX (US)

(72) Inventors: Frankie A. Basso, Dallas, TX (US); Andrea Chiappe, Dallas, TX (US)

(21) Appl. No.: 13/864,983

(22) Filed: Apr. 17, 2013

Related U.S. Application Data
(60) Provisional application No. 61/635,187, filed on Apr. 18, 2012.

(51) Int. Cl. H04L 29/06

(52) U.S. Cl. CPC H04L 65/403
USPC 715/753

(57) ABSTRACT

The improved system and method for allowing the exchange of information regarding document content under review while remaining device agnostic. The system accesses a document repository where document content and metadata related to that content may be stored. The system is operable on a computing device and allows users to access the content using a communication device with or without display technology. Users may access document content, select points of interest therein, and instantly collaborate with other users regarding the points of interest, through the exchange of interaction messages. Message exchange may be instant or may be passive through emailed hyperlinks. All exchanged interaction messages become metadata that may be chronologically recalled to assist a user in determining the thought process of the user that created the messages.

### CROSS-REFERENCE TO RELATED APPLICATIONS

This application claims benefit under 35 U.S.C. §119 and incorporates by reference U.S. Provisional Patent Application for SYSTEM AND METHOD FOR EFFICIENT EXCHANGE OF CONTENT WHILE REMAINING DEVICE AGNOSTIC by inventors Frankie A. Basso and Andrea Chiappe, filed with the USPTO on Apr. 18, 2012, with Ser. No. 61/635,187.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to electronic document management and, more specifically, to a device agnostic system and method for multi-user interaction with electronic documents.

2. Description of Related Art Including Information Disclosed Under 37 CFR 1.97 and 1.98

An electronic document management utility is a system of one or more computer databases that is used to store and track electronic documents and/or images of electronic documents. Documents are added to a repository within the management utility to create an initial saved version of each document. Saved documents may then be “checked-out” from the repository, and subsequently modified to create additional versions. When the modified version is “checked-in” to the repository, the management utility saves a new version of the document (the modified version) in addition to the original version. This cycle may be repeated as often as necessary, with the management utility incrementing the document version number in some logical fashion. One of the benefits of such a document management utility is the ability to track the original document text through each revision, in order to monitor all changes that are made. Thus, if a change is incorrect, it is easy to return the document to an earlier version to recover the lost or changed information. This allows the business to maintain the integrity of its business information and provides an easy means for auditing the history of a given document.

Documents are typically retained in the repository in a native document editing format. For example, a contract drafted in Microsoft Word is stored in the repository as a Word file. Access to the document, thus, requires each user to have Microsoft Word in order to manipulate the file. This limits the types of computer hardware that allow access and manipulation of stored files to only those types of hardware capable of handling the native document format. For example, a user may access the native Word document using a desktop computer having document editing software capable of manipulating Word documents. However, the user may not be able to access the same document using a cell phone or tablet computer.

Most document editing software has functionality that allows for tracking changes made to a document or for adding comments for review. While this is helpful for multi-user collaboration on a document, such functionality requires that each collaborating user have available a compatible version of the document editing software. Again, this restricts the ability to collaborate on a document to only those platforms that are capable of running the editing software, and precludes access to the document by all other users, which can be highly inefficient and inconvenient. For example, an employee that is traveling and that may only have access to a cell phone would be unable to access the document until he or she locates and has access to a desktop computer capable of running the necessary document editing software.

Another problem with traditional document management utilities is the fact that revisions and comments are stored within the document file structure itself. Access to the comments or revisions therefore requires the same document editing software that created the file, revisions, and comments. Again, this limits access to documents to hardware platforms capable of running the document editing software that created the file, revisions, and comments. It would be helpful if a document management utility allowed users to access stored documents and to allow users to comment or revise the documents regardless of the accessing user's hardware platform and software.

### BRIEF SUMMARY OF THE INVENTION

A device for providing device-agnostic electronic document content interaction between each of a plurality of users, each user having a communication device, with the device including a computing device configured to retrieve one or more electronic documents and to present the documents to each of a plurality of users through each user's communication device, whereby each user may interact with other users over one or more points of interest within the documents, the interaction occurring through exchange of interaction messages containing text, audio, or video information, the exchange facilitated by the computing device, the interaction messages associated by the computing device with the one or more points of interest.

A system for providing device-agnostic electronic document content interaction between each of a plurality of users, each user having a communication device, the system including one or more computing devices configured to retrieve one or more electronic documents and to present the documents to each of a plurality of users through each user's communication device, whereby each user may interact with other users over one or more points of interest within the documents, the interaction occurring through exchange of interaction messages containing text, audio, or video information, the exchange facilitated by the computing device, the interaction messages associated by the computing device with the one or more points of interest; and an electronic document repository accessible by the one or more computing devices.

A device-agnostic electronic document content interaction between each of a plurality of users, each user having a communication device, the method steps including presenting, from a first computing device, electronic document content to a first user through a first communication device, wherein the first computing device is configured to accept selection of one or more points of interest within the electronic document content; accepting, from the first user, at least one content interaction message related to the one or more points of interest; associating the at least one content interaction message with the one or more points of interest to which said message is related, and storing the message such that the association and chronological order in which the message was accepted is determinable; presenting, from the first computing device, the electronic document content and the at least one content interaction message to a second user through a second communication device, wherein the at least one content interaction message is presented to the second user with the associated point of interest; accepting, from the second user, at least one content interaction response message related to the one or more points of interest; associating the at least one content interaction response message with the one or more points of interest to which said response message is related, and storing the response message such that the association is determinable; and presenting, from the first computing device, the electronic document content and the content interaction message and the content interaction response message to the first user through the first communication device or through a third communication device, wherein the content interaction message and the content interaction response message is presented with the associated point of interest.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 is a block diagram representing the components of a system in accordance with an embodiment of the present invention;

FIG. 2 is a block diagram representing the software application layers in accordance with an embodiment of the present invention;

FIG. 3 is a depiction of an embodiment of the user interface login screen in accordance with an embodiment of the present invention;

FIG. 4 is a depiction of an embodiment of the user interface capture menu screen in accordance with an embodiment of the present invention;

FIG. 5 is a depiction of an embodiment of the user interface capture menu screen electronic upload window in accordance with an embodiment of the present invention, allowing electronic upload of documents;

FIG. 6 is a depiction of an embodiment of the user interface capture menu screen folders window in accordance with an embodiment of the present invention, allowing a user to view contents of the system folder within which captured documents are stored;

FIG. 7 is a depiction of an embodiment of the user interface capture menu screen capture request window in accordance with an embodiment of the present invention, allowing a user to create a capture request message to be sent to another user;

FIG. 8 is depiction of an embodiment of a capture request email message as created in accordance with an embodiment of the present invention in response to a capture request entered by a user;

FIG. 9 is a depiction of an embodiment of the user interface find menu screen depicting the document search functionality in accordance with an embodiment of the present invention;

FIG. 10 is a depiction of an embodiment of the results page generated in response to a document search in accordance with an embodiment of the present invention;

FIG. 11 is a depiction of an embodiment of the user interface workflow menu screen in accordance with an embodiment of the present invention, representing a “to-do” list for a given user;

FIG. 12 is a depiction of an embodiment of the work results page generated in accordance with an embodiment of the present invention when a user selects a particular “to-do” item from his or her workflow list;

FIG. 13 is a depiction of an embodiment of the user interaction interface in accordance with an embodiment of the present invention;

FIG. 14 is a depiction of an embodiment of the user interaction interface in accordance with an embodiment of the present invention, showing a list representing the interaction history of a user;

FIG. 15A is a flow diagram depicting certain processing steps taken in accordance with an embodiment of the present invention in allowing the addition of user interaction with a content object;

FIG. 15B is a flow diagram depicting certain processing steps taken in accordance with an embodiment of the present invention in allowing the recipient of a user interaction to receive and respond to the interaction;

FIG. 16 is a flow diagram depicting certain processing steps taken in accordance with an embodiment of the present invention in allowing a user to interact with a content object by adding a summary message;

FIG. 17A is a flow diagram depicting certain processing steps taken in accordance with an embodiment of the present invention in allowing the addition of user interaction with a content object in the form of an email interaction message; and

FIG. 17B is a flow diagram depicting certain processing steps taken in accordance with an embodiment of the present invention in allowing the recipient of a user interaction email message to receive and respond to the interaction.

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood. (58,266).

### DETAILED DESCRIPTION OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

As used herein “computer readable medium” means any tangible portable or fixed RAM or ROM device, such as portable flash memory, a CDROM, a DVDROM, embedded RAM or ROM integrated circuit devices, optical media, or the like.

The term “computer processing device” or “computing device” means any electrical device capable of accepting stored program instructions from a computer readable medium and processing those program instructions to perform a defined task. Such devices include, but are not limited to, a mainframe, workstation, desktop, laptop, notebook, or tablet computer, a database server, web server, or the like. One of ordinary skill will appreciate that the construction, choice of programming language, programming, operation, and functionality of such computer processing devices is well known, rendering further description of such devices unnecessary in this regard.

The term “user communication device” means any device capable of transmitting and receiving voice and/or digital data, regardless of frequency, including, but not limited to, wired or wireless mobile communications devices, cellphones, smart phones, VOIP telephones, landline telephones (analog and/or digital), computer processing devices, and the like.

The term “electronic document” means any information recorded or stored in a manner that requires a computer processing device to display, interpret, or otherwise process. This includes, but is not limited to, documents (for example, text, spreadsheets, graphics, video, audio, or some combination) generated by software and/or stored on computer readable medium, as well as electronic mail and documents transmitted in standardized formats including electronic data interchange (EDI).

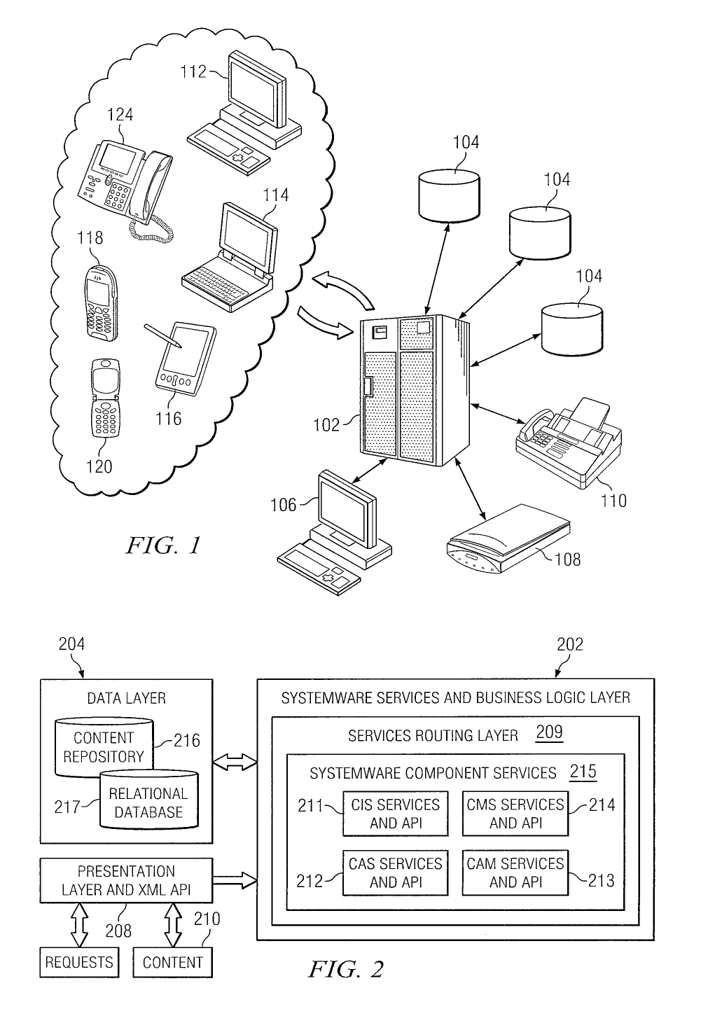

FIG. 1 depicts a block diagram representing the components of the system in accordance with a first embodiment of the present invention. As shown, at least one computer processing device (102) is provides the functionality for device-agnostic electronic document content interaction between each of a plurality of users, with each user having his or her own communication devices. This computing device (102) is configured to retrieve one or more electronic documents from one or more databases or document repositories (104) and to present these documents to each of the plurality of users through each user's communication device (112, 114, 116, 118, 120, or 124). With this wired or wireless communication device (112, 114, 116, 118, 120, or 124) and the facilitating computing device (102), each user can interact over points of interest in a document with other users by exchanging interaction messages containing text, audio, or video information (or some combination of formats).

The document repository of this embodiment is a computing device upon which a relational database is operable. The repository database accepts electronic document content for storage, and allows for relatively effortless retrieval of such documents. The repository may also include versioning software, which maintains each edited version of a stored document under an incremental version number such that prior versions of the document may be recalled for purpose of review of further editing. Such document repositories may be operable on the same hardware as the system computer processing device (102), or may be stand alone as depicted (104). One of ordinary skill in the art to which the invention pertains will appreciate that the configuration and operational details of such document repositories are commonly known and understood.

Electronic documents may be added to the repository (104) directly or through the computer processing device (102) using methods such as by creating and/or uploading the document directly or through email (106), by scanning (108), by facsimile (110), or otherwise converting the document to create a digital copy, whether directly editable or not. For example, the digital copy of the electronic document may be in an image format, may contain editable text, video, or audio data, or may contain some combination.

The computer processing device (102) is capable of running a stored software program to perform the functionality as disclosed herein. This functionality may be reduced to software application layers that perform various sub-functions. FIG. 2 presents a block diagram representing the various software application layers in accordance with an embodiment of the present invention. The functionality of the system (102) of the present embodiment is divided into a relational database layer (206), a content repository layer (204), a services and business logic layer (202), and a presentation layer (208). Although there is described herein a distinct arrangement of application layers, other embodiments may provide the functionality with greater or fewer number of layers, and may combine or duplicate certain functionality within adjacent layers. Such embodiments are within the scope of the present invention.

The services and business logic layer (202) is the interface layer between the Data Layer (204) and to the presentation layer (208). This layer contains the business logic components and services required to perform the tasks of CITE which include Services Routing Layer (209), CIS Services (210), CMS Services (211), CAS Services (212), and CAM Services (213). The Services Routing Layer (209) is composed of those services responsible for the management and routing of the component services. As requests come in Routing layer services handle registration, routing, authentication, and authorization. Within the distinct component services requests and transactions are routed to the applicable component within the Systemware Component Services (215). The CIS Component service (211) allows access to content in any repository utilizing the repository-level metadata and repository-provided capabilities handling notification, mapping, and caching. The CMS Services (214) provides single function services utilizing managed metadata for content identification, discovery, management, distribution, transform, and event driven internal and external actions. The CAS Services (212) provides commonly used functional combinations of business logic which include content collating, records management, content retrieval, content distribution, content capture, workflow, and metadata capture. The CAM Services (213) provides application module containers for purpose-driven processing and presentation of external data, metadata, and content in a business context. The services layer (202) is responsible for SOA processing user requests to capture, find, work, and interact.

The data layer (204) is comprised of the secure Content Repository (216) and the Metadex Relational Database (217). The Content Repository (206) is responsible for housing content data (210), housing content related index data, applying archival rules, and compressing content data. The Metadex (217) is responsible for housing metadata, workflow definitions, work queues, notification queues, and other transactional data required by the Services and Business Logic Layer (202). The data layer is accessed from the Services Routing Layer (209) while related processing occurs within the Component Services (215).

The services and business logic layer (202) is the interface between the data layer (204) and the presentation layer (208), further abstracting the complexities of the data layer (204). This layer includes the component services (215) which are responsible for receiving, processing, sending, notifying, transforming, logging, and responding to ICI requests.

Electronic document content (210) is imported into the presentation or XML API (208) layer and then sent to the service layer (202) where it is processed by the system. The Services bbRouting Layer (209) ensures that the imported content data is properly stored within the repository (204) for access by the system. Ther Services Routing Layer (209) additionally ensures the content is appropriately processed within the Systemware Component Services layer (215). This content (210) includes electronic document data obtained from various sources, including business and legacy data base systems and third party data archives accessible through a service oriented architecture (SOA) application program interface (API); data uploaded to the system through a Web browser application; documents created through word processing software; digital audio and/or video recordings; and document data obtained by scanning paper documents.

The presentation layer (208) provides yet further abstraction of the complexities of the underlying application layers, and allows third party access through various API calls. This layer generates the user interface through which a user may access the system. Access to the system may be through a dedicated user interface originating from this layer or a Web browser making appropriate API calls within this layer. Document content and interaction messages are processed and presented for display to the user by this layer.

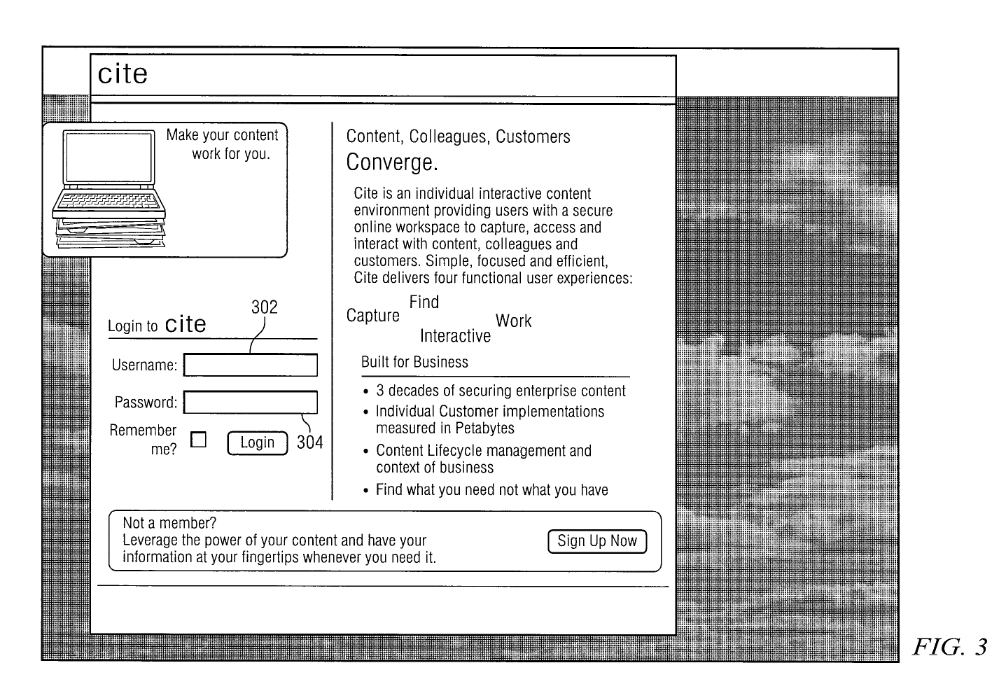

Images of the user interface generated by the presentation layer (208) are provided in the following figures. For example, FIG. 3 provides a depiction of an embodiment of the user interface login screen in accordance with an embodiment of the present invention. As shown, a user enters his or her username (302) and password (304) in order to log into the service. On login, the service accesses the stored user profile to determine access rights and user system configuration details.

In the present embodiment, multi-factor authentication (MFA) may be enabled for certain users. For security purposes, MFA requires that authentication questions may be asked of the user, and correct answers are required before access to the system is granted. Answers to such authentication questions may be established upon initial creation of the user's account or upon subsequent editing of the user's account profile. Authentication questions may be bypassed if the user indicates that the computer through which the user is accessing the system is a trusted or authorized computer. During user login the system embodiment checks to see if a token (i.e., cookie) is present on the user's computer. If it is not present, the system prompts the user to determine if the user wishes to “trust” or “authorize” the given computer for subsequent access. If the user selects the prompt to “trust” or “authorize” the computer, an authorization token (cookie) is placed on the computer and subsequent logins do not generate authentication questions. If, however, the computer is used by others (for example: a computer lab), then the user may wish to not “trust” or “authorize” the computer. This prevents placement of the token and causes subsequent logins to generate authentication questions. In another embodiment, another cookie is deposited on the user's computer indicating that the computer is not trusted/authorized, which causes subsequent logins to skip the request for authorization and to immediately generate authentication questions.

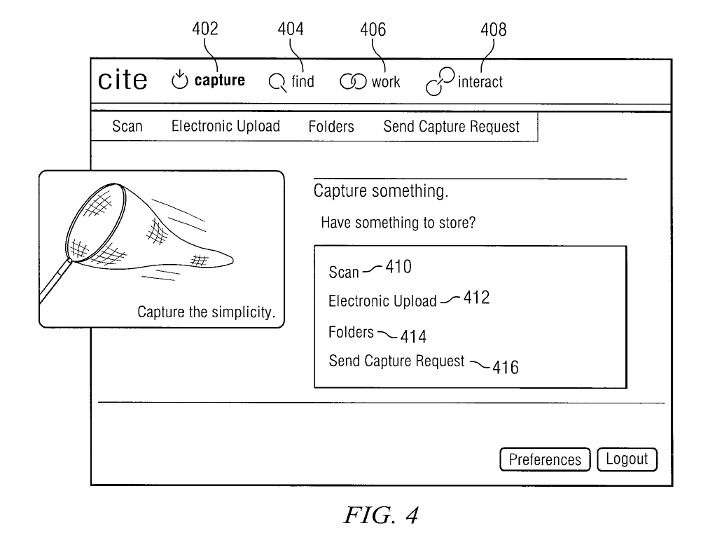

Following login, the system presents a menu of options for the user to select. FIG. 4 presents a depiction of an embodiment of the user interface capture menu screen in accordance with an embodiment of the present invention. As shown in this figure, the menu options include capture (402), find (404), work (406), and interact (408). The instant UI screen shows the capture option, which allows capture of document content upon which the system may act. Under the capture option, the user is given the additional option of selecting the mode of capture, including by scanner (410), electronic upload (412), or folder (414), or the user may send a capture request to another user (416). Users may scan documents directly to the system, which allows for large batches and small ad hoc scans to be captured securely into the document repository. The UI also allows a user to browse to documents stored on their local or networked machines and upload them directly to the system. Like the scan feature, this mechanism allows for batch and ad hoc documents to be captured to the document repository.

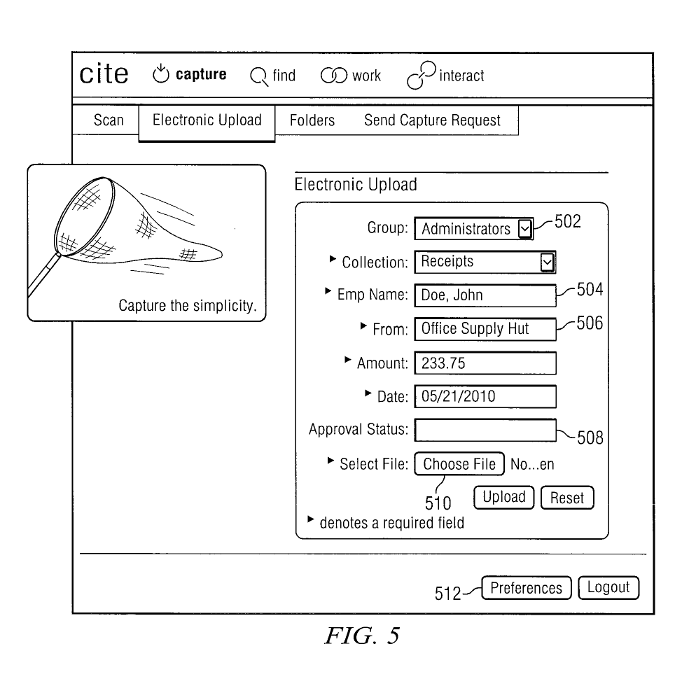

FIG. 5 depicts an embodiment of the user interface capture menu screen electronic upload window in accordance with an embodiment of the present invention, allowing a user to upload documents to the system electronically. The UI allows end users to capture content to a secure location for storage and archival. Capture allows for intelligent indexing to be applied using index maps to the content being captured. This approach is what allows content to be easily retrieved during search for future use. To achieve this, intelligent indexing is applied in one or more indexing approaches including: manual, OCR, BCR, ICR, Semantic, Voice Indexing, full text, and any hybrid combination of these indexing methods. The indexing maps are created and administered by the end users from the UI. When content is captured specific security in capture is a key focus of the application extending to data in transit, storage, and in use. As depicted, the system requests additional information from the user regarding the electronic document, including the group and collection to which the document is to be assigned (502); the name of the submitting user (504); the name of the originator of the document (506); approval status (508); and the like. Once this data is entered, the user enters the file path (510) to the document on the user's computing device and then selects the “Upload” option (512) to begin transfer of the document to the system. This electronic document data is added to a database table and associated with the uploaded document. In another embodiment, this document data is treated as metadata for subsequent access to and processing of the document.

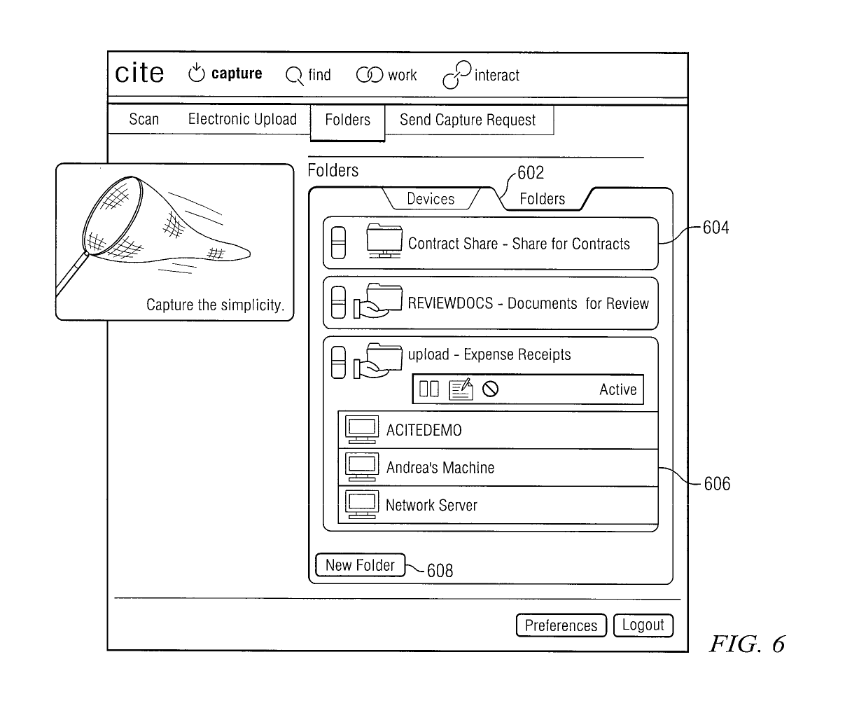

FIG. 6 depicts an embodiment of the user interface capture menu screen folders window in accordance with an embodiment of the present invention, allowing a user to view contents of the system folder within which captured documents are stored. As shown, using this UI allows the user is allowed to view files on a connected device or system folder (602). The folder information includes system share folders (604) on other networked computers as well as a default “upload” folder in addition to a status display of the uploaded file (606). Current upload task process is presented, in addition to control buttons for functionality related to the upload. New system folders for storage of uploaded documents may also be created (608). The system offers a unique ability for users to create, use, and administrate folders on their local or network systems. These folders automatically upload content placed into them directly to the document repository. Users have two types of capture folders that can be created: shared and monitored. Shared allows for native collaboration on their local systems while maintaining versions and history in the document repository. Any user who has the share folder on their system benefits from receiving all automatic updates directly to their device. Monitored allows for direct capture of any content dropped into the folder to be moved securely to the document repository.

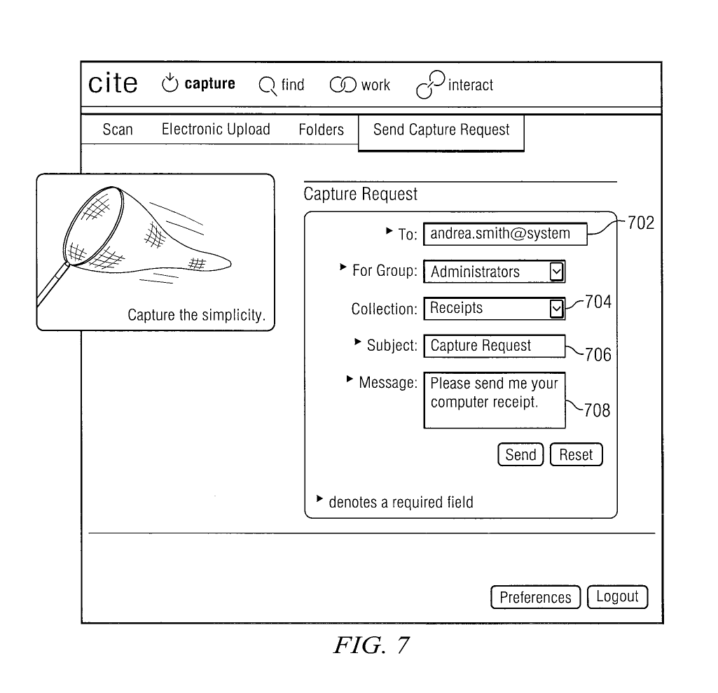

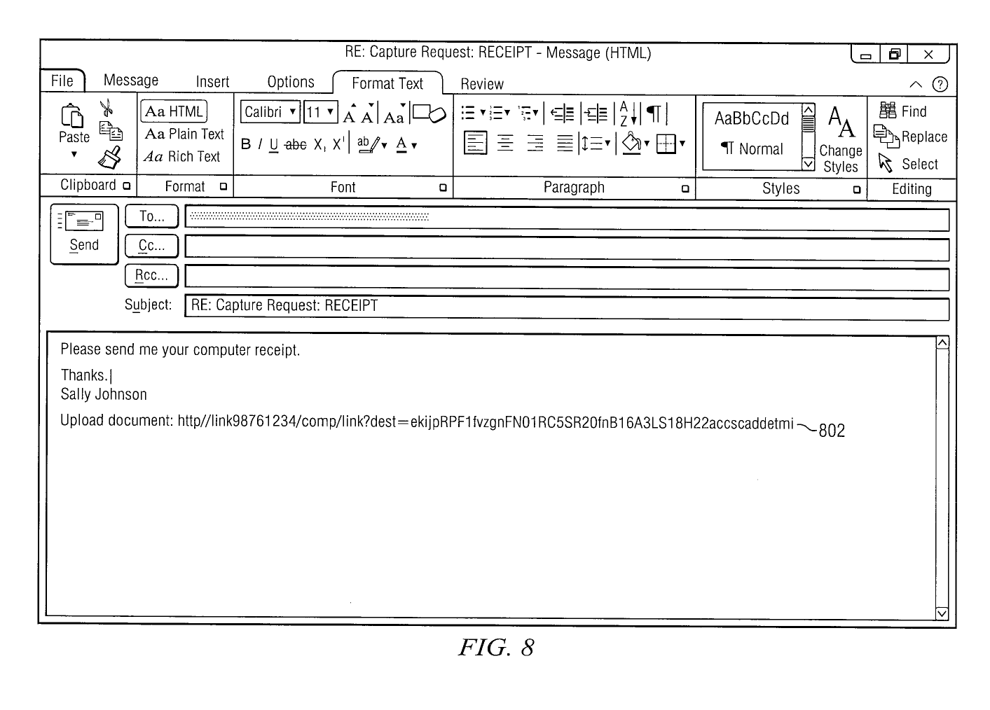

FIG. 7 depicts an embodiment of the user interface capture menu screen capture request window in accordance with an embodiment of the present invention, allowing a user to create a capture request message to be sent to another user. The system offers through the UI or on a scheduled basis the ability for end users to send requests to users or non-users for specific document content. The notification is sent in an email to the desired collaborating recipient. Once a notification is received, the user is able to click a link, which presents to him or her a location into which to copy the requested content. When the request is generated the originator determines whether the link should be one time use, time expired, or upon complete capture expired. For example, a user may be aware of receipts that must be entered by a coworker for an expense report, so the user may create a capture request to be sent to the coworker as a reminder to submit the receipts. The system requests information for the message and the requested document such as the email address of the other user (702); the group and collection to which the requested document is to be assigned (704); a subject for the message (706); and additional text to provide within the body of the message (708). Once the “Send” button is pressed, an email to the other user is generated such as that depicted in FIG. 8. In this figure, the email to the other user includes a hyperlink to a folder on the system (802). The user that receives the email may then select the link to automatically begin the upload. If the link was designated as “one time use,” then the link expires once it is selected. If “time expired,” then the link must be utilized within the stated time. If “upon complete capture expired,” then the link will remain active until the capture (i.e., upload) process completes.

The system UI also has unique interaction messaging and live-interaction capability. By virtue of this capability the interaction points themselves become valid pieces of content that are stored for subsequent search and retrieval. This instant content interaction (ICI) can be stored as static content or can be used as dynamic “living” content that may be altered as it is accessed.

The system document repository folders may also be searched. The system UI allows end users locate content securely that has been stored by them or a group of which they are a member. The find functionality utilizes and extends the same index templates that are used for capture to search for document content. An end user can perform quick searches on any index or advanced searches on combinations of the indexes within the UI. Quick find applies search criteria to all indexes across the selected map corpus, whereas advanced find applies search criteria to selected indexes across the selected map corpus allows for operands and combination searches. Other functionality includes combine-to-PDF and to-go folder. Combine-to-PDF combines selected search results into a single PDF where the chapters are the selected indexes. The combined PDF can optionally be downloaded or recaptured within the document repository as new content. The to-go folder outputs selected search results into a user's designated “To-Go” folder located on their communication device for use while “offline” (i.e., not actively logged into the system for message review).

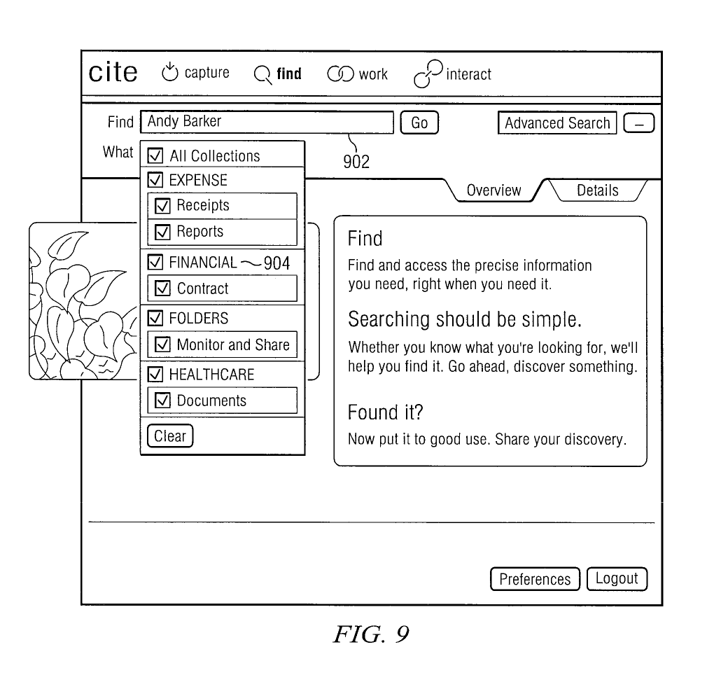

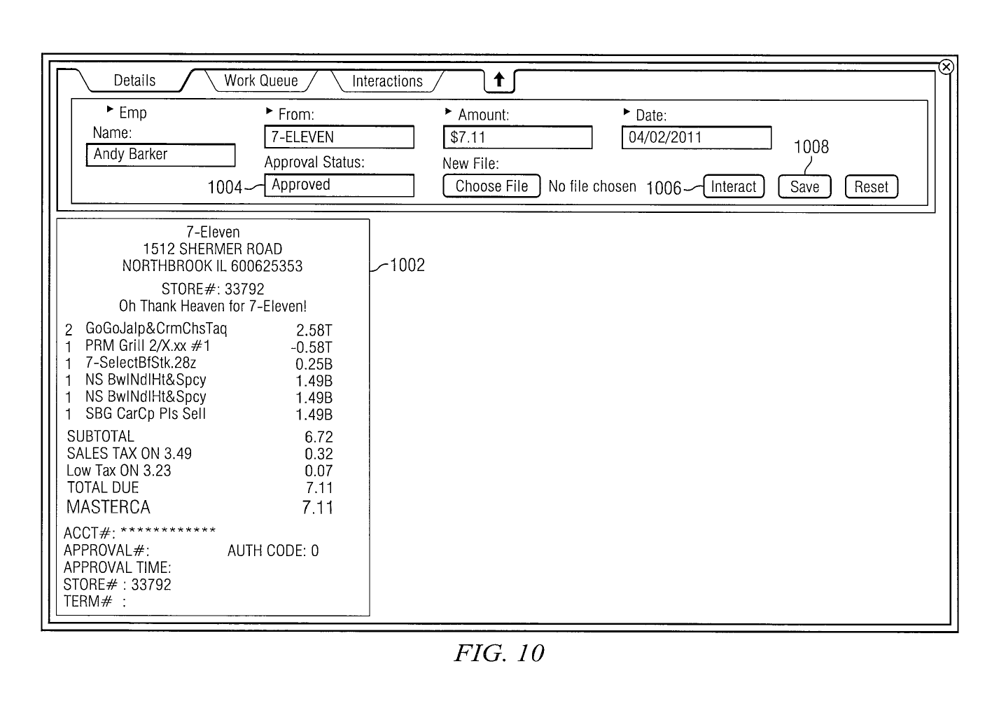

FIG. 9 depicts an embodiment of the user interface find menu screen depicting the document search functionality in accordance with an embodiment of the present invention. As depicted, a user may enter keywords (902) for the document being sought, and may also enter additional search criteria (904) to narrow the search. FIG. 10 depicts an embodiment of the results page generated in response to a document search in accordance with an embodiment of the present invention. As shown in this figure, the electronic document is presented (1002) along with the document metadata (1004). Once the electronic document is located and presented as shown, changes may be made to the metadata (1008), or the user may initiate interaction (1006) with others regarding the document.

Selection of the “work” menu option allows a user to review and work with documents in which the user has an interest. The system UI allows end users to work on content securely which have been assigned to them. The system work functionality offers content based work flows to be created and processed from within the system UI. Examples of these workflows include: approvals, reviews, votes, capture, output, notification, interact, signature, index, validate, delete, and the like. As with all elements of the system, complete audit logs are created for every such interaction. Workflow assignment is at the user(s) or group(s) level and is processed in parallel or sequentially based on configuration through the UI. Workflows can be scheduled, predesigned, or ad-hoc.

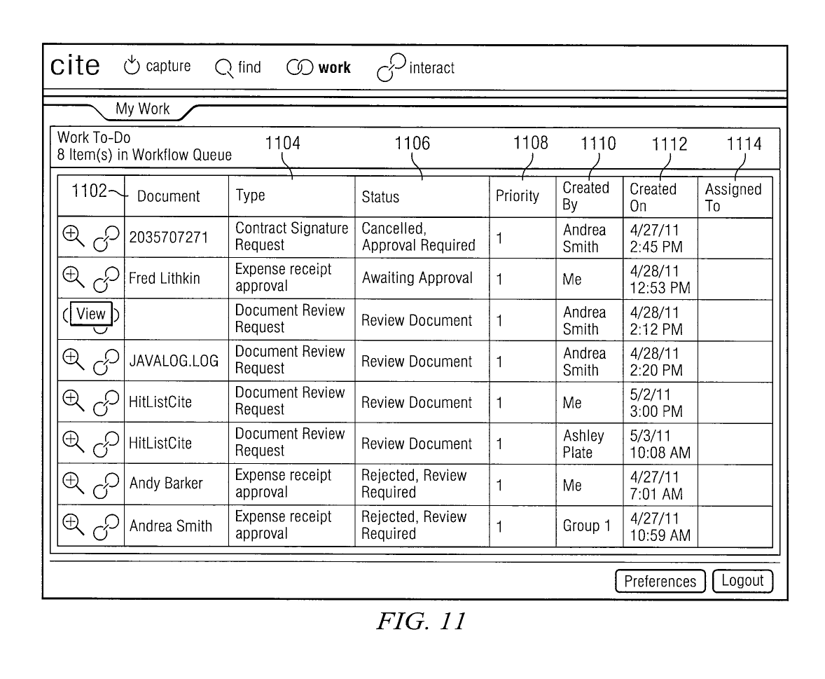

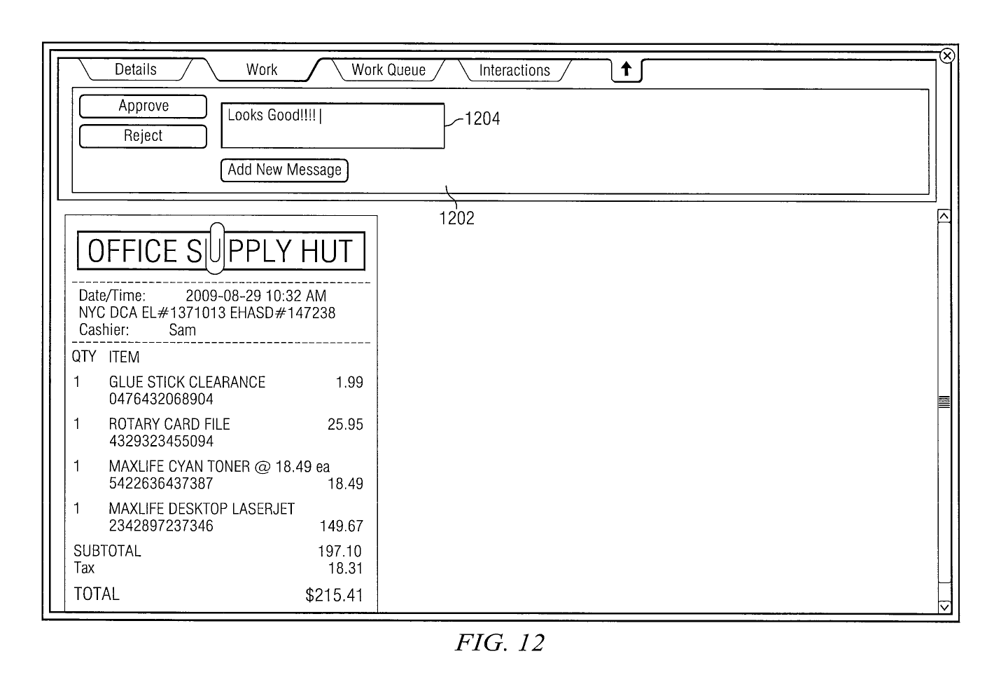

FIG. 11 is a depiction of an embodiment of the user interface workflow menu screen in accordance with an embodiment of the present invention, representing a “to-do” or status list for the documents belonging to a given user. The UI presents each document in a spreadsheet format, with details for each document such as a Document identifier (1102), a document Type (1104), the Status of the document (1106), an assigned Priority for the document (1108), who created the document (1110), when the document was created (1112), who the document was assigned to for review (1114), and the like. If a document is selected, details for the document are presented to the user as in FIG. 12.

FIG. 12 depicts an embodiment of the work results page generated in accordance with an embodiment of the present invention when a user selects a particular “to-do” item from his or her workflow list. From this UI, the user may mark the document as approved or rejected (1202), or may add a message (1204) to communicate with another user.

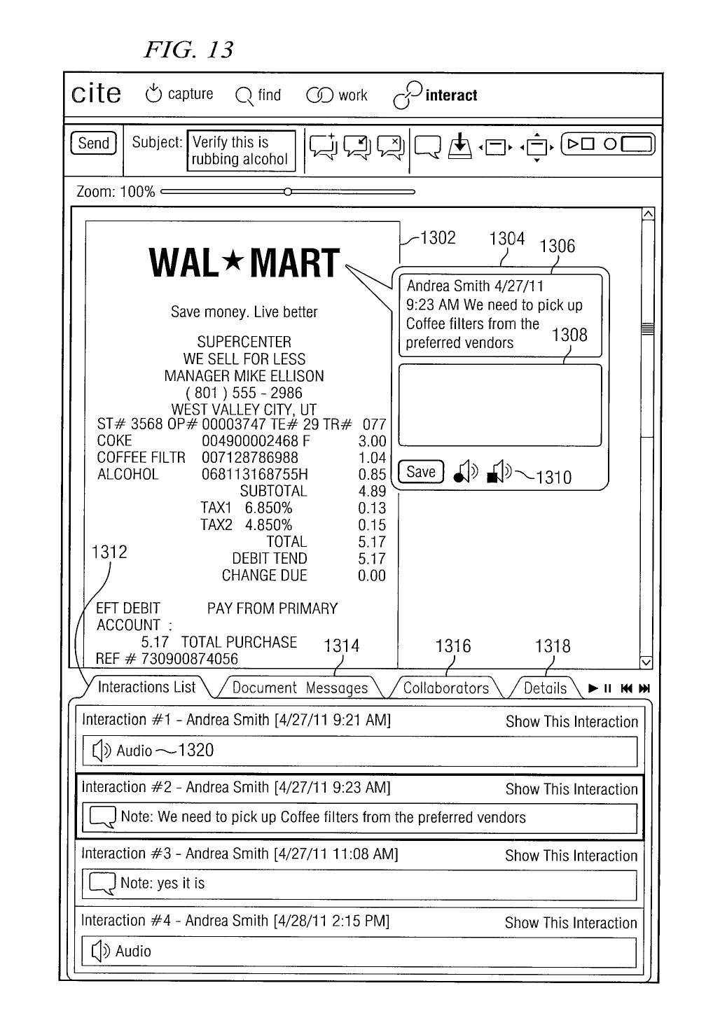

The system also allows users to interact with other users (collaborators) over the content of a document or groups of documents. Selection of the “interact” menu option engages this functionality. The system UI allows end users to interact about content with other users or non-users with whom they invite into their interaction, whereas the “work” functionality offers content based work flows to be created and processed from within the UI. The “interact” functionality can be broken into three categories: instant content messaging (ICI), passive interaction notification (PIN), and present interaction (PI). All interactions are stored in the repository as versions of interactive content viewable from within the system UI. FIG. 13 depicts an embodiment of the user interaction interface in accordance with an embodiment of the present invention. As depicted, the UI presents a selected document (1302) for ICI.

The user may select a point of interest within the document, and attach an interaction message (1304) to the point of interest. In this embodiment, the interaction message (1304) appears as a popup “bubble” as shown. Within the popup is space for display of prior collaborating user comments (1306) as well as space for entry of interaction response messages (1308). The collaborating user may type, using his or her keyboard, a message into the message space (1308), causing the system to store the message and additional metadata information including: document point of interest location; user identification; time and date of the entry; and other metric data for subsequent recall. If the user wishes to record a voice message instead of using a keyboard or keypad for entry, or if the user's communication device does not have a keyboard or keypad, he or she may also record a voice message (1310). The system stores the voice message in the same manner as the textual message, or may convert the audio to text and may store both for subsequent retrieval. In another embodiment, the system also allows recording of a message containing audio and/or video. One of ordinary skill will appreciate that an interaction response message is a message in response to an initially created interaction message (text, audio, and/or video), and can include any number of iterations of response.

The UI also provides a listing of each of the interaction messages/interaction response messages (1312) associated with the particular document content. Depicted is such a listing (1320), showing that an audio message associated with a point of interest within the document, including three additional responses to the initial message. A user may review each message by selecting the particular message of interest (in this case, the second entry), or may select the “next” message button for chronological display of the message/message response sequence. The chronological display of interaction messages/interaction response messages allows a user to more readily ascertain the context of a given interaction or group of interactions, which is more meaningful than trying to interpret a message out of context. Other display alternatives include a display of each of the document messages (1314), a listing of the collaborators for the particular document (1316), and a listing of details (such as metadata) for the document (1318). Each interaction message is represented on the document at the associated point of interest (1322) as a thumbnail image, until the message or thumbnail is selected, at which time the thumbnail turns to a popup “bubble” for conveyance to the user of the associated interaction message data.

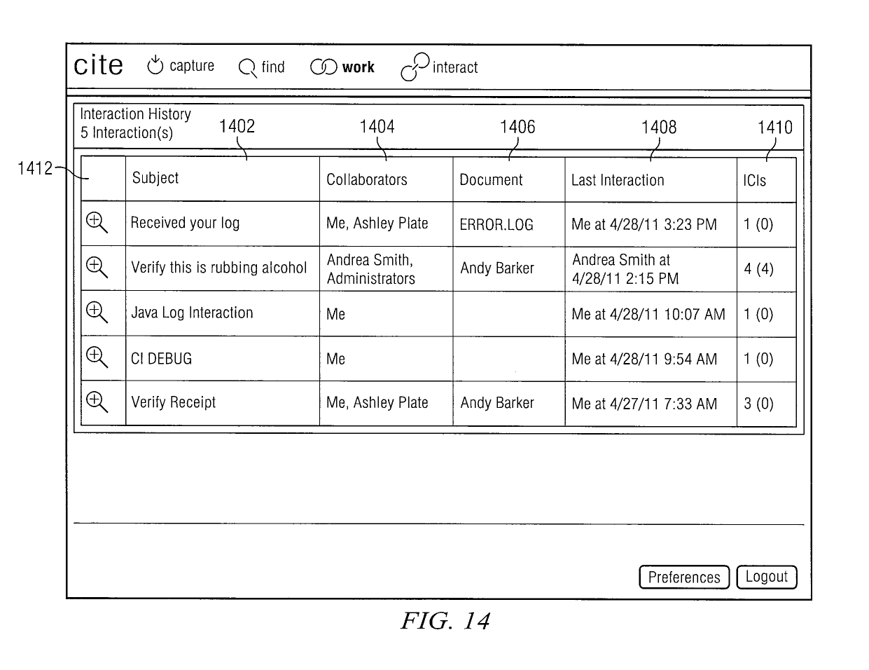

Another option for viewing is of the interaction message history as in FIG. 14. This figure depicts an embodiment of the user interaction interface in accordance with an embodiment of the present invention, showing a list representing the interaction history for a particular document. This listing includes the subject of the interaction (1402), the collaborators for a given interaction (1404), associated documents (1406), the date of the last interaction (1408), and the number of interactions (1410). The document and interactions may also be viewed and interacted upon by selecting the desired entry (1412).

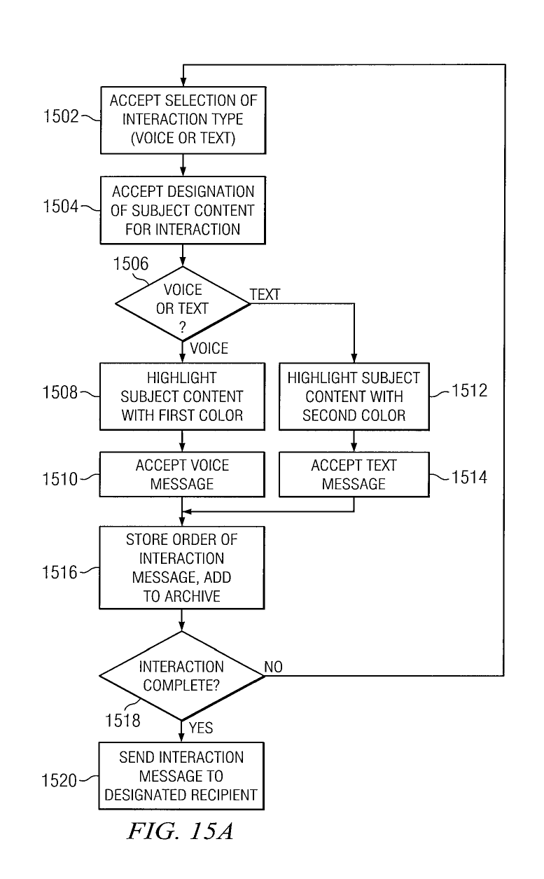

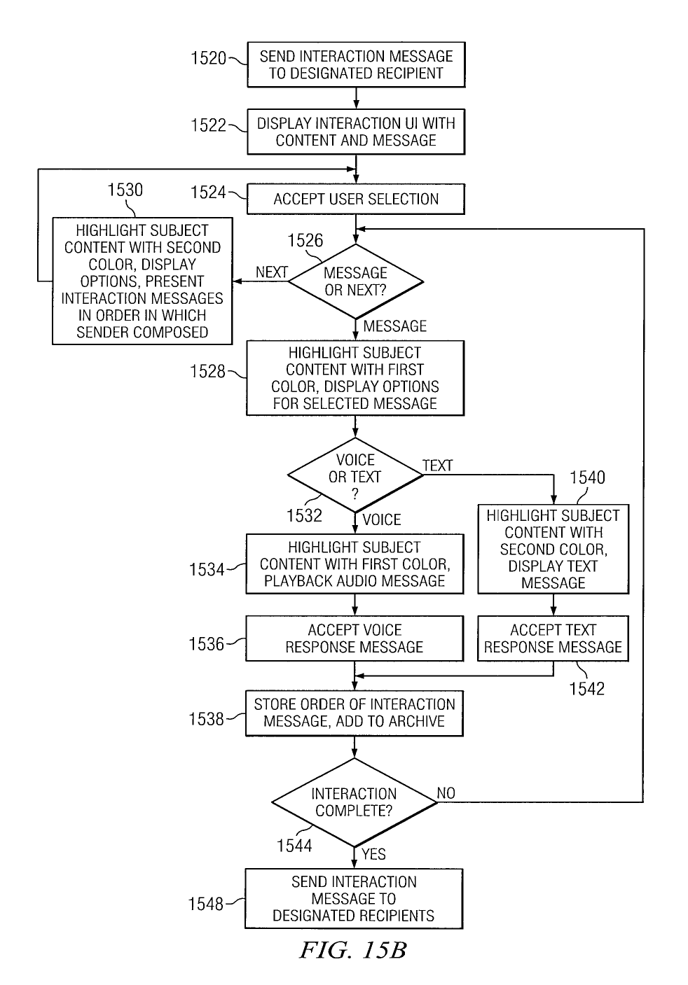

FIG. 15A presents a flow diagram depicting certain processing steps taken in accordance with an embodiment of the present invention in allowing the addition of user interaction with a document content object during ICI. As previously described, collaborating users may interact over selected document content. The document content and interaction message is displayed in a portable format within the user's communication device. In this embodiment the complete document content is provided in a format that is viewable on any communication device having a display screen capable of displaying the system UI or a web browser. For example, the document content is provided as an image file, including TIFF or JPEG format. After selecting a point of interest within a document, the system allows the user to choose between voice or text message interaction (1502). In another embodiment, the system also allows a user to record an interaction message as video, which may also include audio.

The system then accepts designation of subject document content for interaction (1504). For example, the system allows the interacting user to select an area of the document image as a point of interest. The system remembers this point of interest and stores its location in conjunction with the user's interaction message. If the user wishes to leave a voice interaction message (1506), the system highlights or otherwise visually designates the subject content with a first color such that it stands out from the remaining document content (1508). Next, the user may record his or her voice message (1510) for subsequent archival with the additional message metadata (1516). Likewise, if a text interaction message is desired (1506), the system highlights or otherwise visually designates the subject content with a second color such that it stands out from the remaining document content (1508). Next, the user enters his or her text message (1514) for subsequent archival with the additional message metadata (1516). If additional interaction messages are desired (1518), the process repeats with selection of the interaction type (1502). If the interaction is complete (1518), the system sends the interaction message to the designated collaborating user or users for review and consideration (1520).

FIG. 15B presents a flow diagram depicting certain processing steps taken in accordance with an embodiment of the present invention in allowing the recipient of a user interaction to instantly receive and respond during the ICI interaction phase. Once the collaborating user receives the interaction message (1520), the document content and interaction message is displayed in a portable format as a popup message within the receiving user's communication device display (1522). In this embodiment the complete document content is provided in a format that is viewable on any communication device having a display screen capable of displaying the system UI or a web browser. For example, the document content is provided as an image file, including TIFF or JPEG format. Likewise, the interaction message may also be provided in a similar format, with an area available for entry of a response text message using the communication device keyboard, keypad, or audio capabilities.

From the display, the collaborating user is allowed to select how he or she wishes to review the interaction messages (1524), if multiple interactions are provided. If the user chooses to review the messages in chronological order (1526), the system presents the first chronological interaction message and highlights or otherwise visually designates the subject content with a color. The system also presents message review options to the user, and allows the user to select (1524) a particular message or to view the next message (in chronological order). If a message is selected (1526), the system highlights or otherwise visually designates the subject document content and interaction message text with a color such that it stands out from the remaining content, and presents options for acting upon the message. If the interaction message is a voice message (1532), the system plays the voice message to the user over the user's communication device (1534). If the user wishes to respond with a voice response message, the system allows recording of such a response message (1536) and subsequently archives it for later recall (1538). If, instead, the interaction is a text message (1532), the system displays the text message (1540) and message options. If the user wishes to respond with a text response message, the system accepts the text response as entered from the user's communication device keyboard or keypad (1542) and subsequently archives the message for later recall (1538). If the interaction is not complete and additional interaction messages exist (1544), the system presents the next message for review and the process repeats. However, if the interaction is complete (1544), the system archives the new interaction response message or messages and associated metadata and sends the response interaction message to designated collaborating users (1548) wherein it instantly generates a popup message on his or her communication device. This interaction response message process may then be repeated as many times as necessary, to the satisfaction of the collaborating parties. In addition, a collaborating user providing an interaction response message may also include a new interaction message on another point of interest within the document content and may designate other or additional users with which to collaborate over this or any other of the messages.

As previously described, the user may access the system through a UI or a web browser interface operable on his or her communication device. In another embodiment, the user may access the system with a communication device that is incapable of providing a graphical UI or web browser, but instead relies on audio only. For example, a landline telephone may be utilized. In such an embodiment the accessing user is guided through use of prompts, voice commands, and/or button press combinations to access the system menu and documents for interaction. A voice recognition utility allows the system to recognize spoken voice commands and to perform appropriate routines in response to spoken commands. A text-to-speech utility converts menu items, document content, and interaction messages to speech upon which the user may act. For example, the user may issue a command (voice command or button press combination) to review pending documents. The system “speaks” the available documents until the correct document is located. Once located, the user issues a command (voice command or button press combination) causing the system to “speak” the available document content lines and/or related stored interaction messages. The user may then issue another command to provide an interaction message or a response to an existing interaction message, and may speak the message to the system. The system accepts the spoken message as audio, may convert the audio to text, or both. A collaborating user is then presented with this audio (and/or text) message for subsequent review. In the absence of a display on the communication device, the “popup message” instead is conveyed as a sound accompanying the message. One of ordinary skill will appreciate that voice recognition and text-to-speech utilities are relatively common and well known and, as such, require no further description.

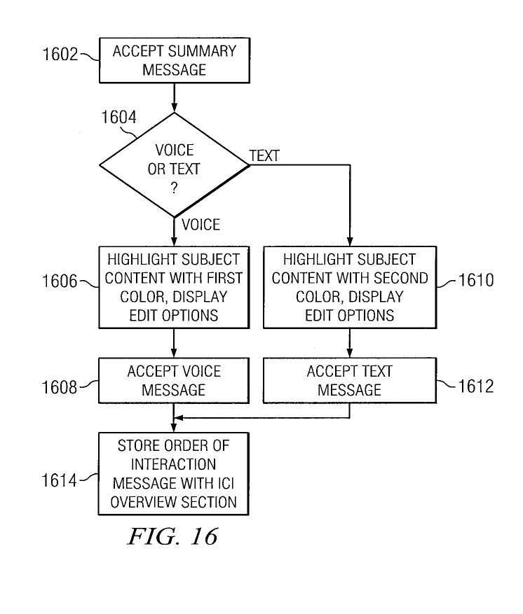

An additional feature provided by this embodiment is the ability to accept summary messages related to a particular document content, without tying the summary message to a particular point of interest within the document. FIG. 16 presents a flow diagram depicting certain processing steps taken in accordance with an embodiment of the present invention in allowing a user to interact with a content object by adding a summary message (1602). As with the previous interaction message steps; the system in this embodiment allows choice of a voice or text interaction message (1604). In another embodiment, the user is allowed to submit a video, with or without audio, as an interaction message.

If a voice interaction message is chosen (1604), the system highlights or otherwise visually designates the subject document content with a color such that it stands out from remaining content, and presents options for acting upon the message (1606). The user may record the voice message (1608), which the system subsequently stores for subsequent chronological retrieval (1614) as with the previously described interaction message/interaction response messages. If a text message is chosen (1604),), the system highlights or otherwise visually designates the subject document content with a color such that it stands out from remaining content, and presents options for acting upon the message (1606). The user may enter the text message (1610), which the system subsequently stores for subsequent chronological retrieval (1614). This summary message may be associated with a single document content, or may include multiple document contents such as a group of documents submitted for a single purpose.

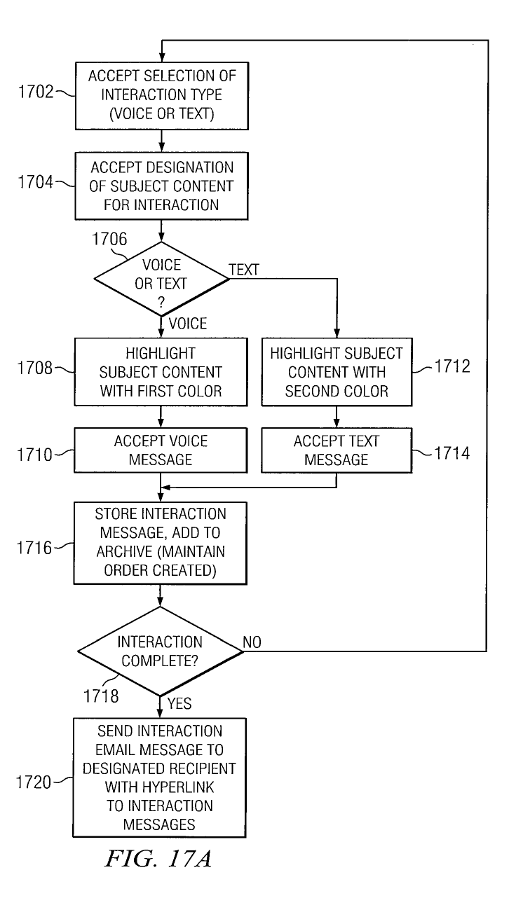

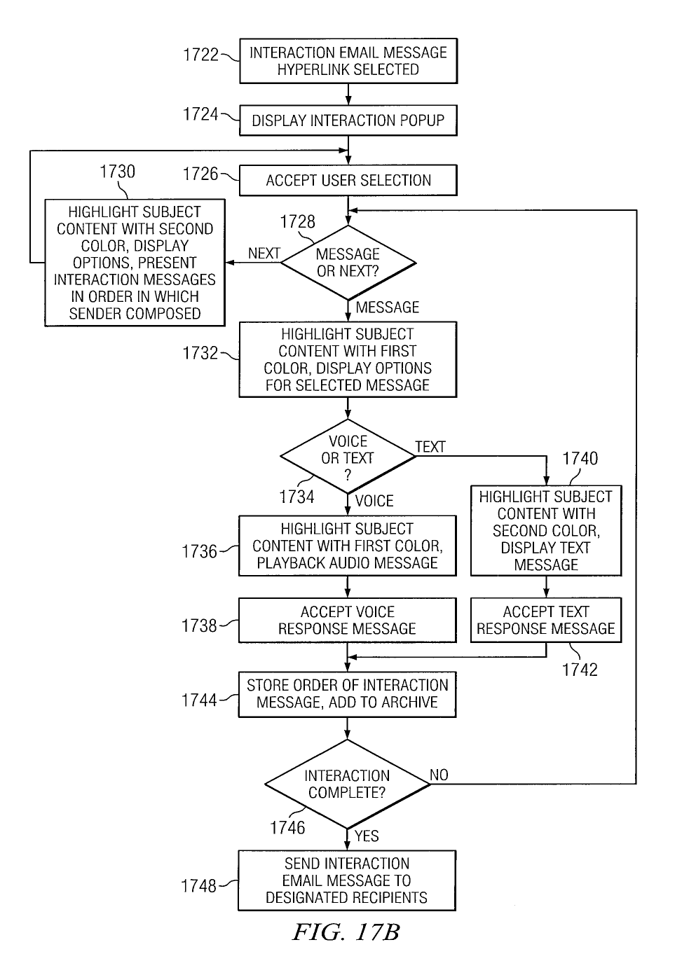

FIG. 17A presents a flow diagram depicting certain processing steps taken in accordance with an embodiment of the present invention in allowing the addition of user interaction with a content object in the form of an email interaction message as PEI. As previously described, collaborating users may interact over selected document content. Again, the document content and interaction message is displayed in a portable format within the user's communication device. In this embodiment the complete document content is provided in a format that is viewable on any communication device having a display screen capable of displaying the system UI or a web browser. For example, the document content is provided as an image file, including TIFF or JPEG format. After selecting a point of interest within a document, the system allows the user to choose between voice or text message interaction (1702). In another embodiment, the system also allows a user to record an interaction message as video, which may also include audio.

The system then accepts designation of subject document content for interaction (1704). For example, the system allows the interacting user to select an area of the document image as a point of interest. The system remembers this point of interest and stores its location in conjunction with the user's interaction message. If the user wishes to leave a voice interaction message (1706), the system highlights or otherwise visually designates the subject content with a first color such that it stands out from the remaining document content (1708). Next, the user may record his or her voice message (1710) for subsequent archival with the additional message metadata (1716). Likewise, if a text interaction message is desired (1706), the system highlights or otherwise visually designates the subject content with a second color such that it stands out from the remaining document content (1712). Next, the user enters his or her text message (1714) for subsequent archival with the additional message metadata (1716). If additional interaction messages are desired (1718), the process repeats with selection of the interaction type (1702). If the interaction is complete (1718), the system sends the interaction message email message to the designated collaborating user or users for review and consideration (1720). The interaction message email contains a hyperlink to the interaction message content.

FIG. 17B is a flow diagram depicting certain processing steps taken in accordance with an embodiment of the present invention in allowing the recipient of a user interaction email message to receive and respond to the interaction. Once the collaborating user receives the interaction email message containing the hyperlink to the message content (1722) and the hyperlink is “clicked” or otherwise selected, the document content and interaction message is displayed in a portable format within the receiving user's communication device (1724). In this embodiment the complete document content is provided in a format that is viewable on any communication device having a display screen capable of displaying the system UI or a web browser. For example, the document content is provided as an image file, including TIFF or JPEG format. Likewise, the interaction message may also be provided in a similar format, with an area available for entry of a response text message using the communication device keyboard, keypad, or audio capabilities.

From the display, the collaborating user is allowed to select how he or she wishes to review the interaction messages, if multiple interactions are provided. If the user chooses to review the messages in chronological order (1726), the system presents the first chronological interaction message (1728) and highlights or otherwise visually designates the subject content with a color (1730). The system also presents message review options to the user, and allows the user to select (1726) a particular message or to view the next message (in chronological order). If a message is selected (1732), the system again highlights or otherwise visually designates the subject document content and interaction message text with a color such that it stands out from the remaining content, and presents options for acting upon the message. If the interaction message is a voice message (1734), the system plays the voice message to the user over the user's communication device (1736). If the user wishes to respond with a voice response message, the system allows recording of such a response message (1738) and subsequently archives it for later recall (1744). If, instead, the interaction is a text message (1734), the system displays the text message (1740) and message options. If the user wishes to respond with a text response message, the system accepts the text response as entered from the user's communication device keyboard or keypad (1742) and subsequently archives the message for later recall (1744). If the interaction is not complete and additional interaction messages exist (1746), the system presents the next message for review and the process repeats. However, if the interaction is complete (1746), the system archives the new interaction response message or messages and associated metadata and sends the response interaction message to designated collaborating users as an email message containing a hyperlink to the interaction response message content (1748). This interaction response message process may then be repeated as many times as necessary, to the satisfaction of the collaborating parties. In addition, a collaborating user providing an interaction response message may also include a new interaction message on another point of interest within the document content and may designate other or additional users with which to collaborate over this or any other of the messages.

As previously described, the user may access the system through a UI or a web browser interface operable on his or her communication device. In another embodiment, the user may access the system with a communication device that is incapable of providing a graphical UI or web browser, but instead relies on audio only. For example, a landline telephone may be utilized. In such an embodiment the accessing user is guided through use of prompts, voice commands, and/or button press combinations to access the system menu and documents for interaction. A text-to-speech utility converts menu items, document content, and interaction messages to speech upon which the user may act. For example, the user may issue a command (voice command or button press combination) to review pending documents. The system “speaks” the available documents until the correct document is located. Once located, the user issues a command (voice command or button press combination) causing the system to “speak” the available document content lines and/or related stored interaction messages. The user may then issue another command to provide an interaction message or a response to an existing interaction message, and may speak the message to the system. The system accepts the spoken message as audio, may convert the audio to text, or both. A collaborating user is then presented with this audio (and/or text) message for subsequent review.

As indicated above, aspects of this invention pertain to specific “method functions” implementable through various computer systems. In an alternate embodiment, the invention may be implemented as a computer program product for use with a computer system. Those skilled in the art should readily appreciate that programs defining the functions of the present invention can be delivered to a computer in many forms, which include, but are not limited to: (a) information permanently stored on non-writeable storage media (e.g. read only memory devices within a computer such as ROMs or CD-ROM disks readable only by a computer I/O attachment); (b) information alterably stored on writeable storage media (e.g. floppy disks and hard drives); or (c) information conveyed to a computer through communication media, such as a local area network, a telephone network, or a public network like the Internet. It should be understood, therefore, that such media, when carrying computer readable instructions that direct the method functions of the present invention, represent alternate embodiments of the present invention.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise. (58,266).

We claim:

1. A device for providing device-agnostic electronic document content interaction between each of a plurality of users, each user having a communication device, said device comprising:
a computing device configured to retrieve one or more electronic documents and to present said documents to each of a plurality of users through each user's communication device, whereby each said user may interact with other said users over one or more points of interest within said documents, said interaction occurring through exchange of interaction messages containing text, audio, or video information, said exchange facilitated by said computing device, said interaction messages associated by said computing device with said one or more points of interest.

2. The device of claim 1, wherein said exchanged messages are presented to each interacting user through each user's communication device, in the chronological order in which said messages were associated with said points of interest.

3. The device of claim 1, said computing device further configured to store said associated messages as retrievable additional electronic document content that remains associated with corresponding said points of interest.

4. The device of claim 1, said computing device generating and storing metadata for subsequent retrieval for characterizing said interaction messages, said metadata to facilitate a contextual understanding of said interaction message exchange.

5. The device of claim 1, said computing device further configured to allow subsequent retrieval of all interaction messages exchanged with regard to an electronic document.

6. The device of claim 1, wherein said exchange between users occurs regardless of functionality disparities among said users' communication devices.

7. The device of claim 1, wherein said computing device presents said electronic documents and said interaction messages in an image format suitable for display on each of said user's communication device.

8. A system for providing device-agnostic electronic document content interaction between each of a plurality of users, each user having a communication device, said system comprising:
one or more computing devices configured to retrieve one or more electronic documents and to present said documents to each of a plurality of users through each user's communication device, whereby each said user may interact with other said users over one or more points of interest within said documents, said interaction occurring through exchange of interaction messages containing text, audio, or video information, said exchange facilitated by said computing device, said interaction messages associated by said computing device with said one or more points of interest; and
an electronic document repository accessible by said one or more computing devices.

9. The system of claim 8, wherein said exchanged messages are presented to each interacting user through each user's communication device, in the chronological order in which said messages were associated with said points of interest.

10. The system of claim 8, said computing devices further configured to store said associated messages as retrievable additional electronic document content that remains associated with corresponding said points of interest.

11. The system of claim 8, said computing devices generating and storing metadata for subsequent retrieval for characterizing said interaction messages, said metadata to facilitate a contextual understanding of said interaction message exchange.

12. The system of claim 8, said computing device further configured to allow subsequent retrieval of all interaction messages exchanged with regard to an electronic document.

13. The system of claim 8, wherein said exchange between users occurs regardless of functionality disparities among said users' communication devices.

14. The device of claim 8, wherein said computing device presents said electronic documents and said interaction messages in an image format suitable for display on each of said user's communication device.

15. The system of claim 8, wherein said electronic document repository operates from said one or more computing devices.

16. A device-agnostic electronic document content interaction between each of a plurality of users, each user having a communication device, said method steps comprising:
presenting, from a first computing device, electronic document content to a first user through a first communication device, wherein said first computing device is configured to accept selection of one or more points of interest within said electronic document content;
accepting, from said first user, at least one content interaction message related to said one or more points of interest;
associating said at least one content interaction message with said one or more points of interest to which said message is related, and storing said message such that the association and chronological order in which the message was accepted is determinable;
presenting, from said first computing device, said electronic document content and said at least one content interaction message to a second user through a second communication device, wherein said at least one content interaction message is presented to said second user with said associated point of interest;
accepting, from said second user, at least one content interaction response message related to said one or more points of interest;
associating said at least one content interaction response message with said one or more points of interest to which said response message is related, and storing said response message such that the association is determinable; and
presenting, from said first computing device, said electronic document content and said content interaction message and said content interaction response message to said first user through said first communication device or through a third communication device, wherein said content interaction message and said content interaction response message is presented with said associated point of interest.

17. The method of claim 16, wherein said electronic document repository operates from said one or more computing devices.

18. The method of claim 16, wherein said content interaction messages and said content interaction response messages are presented to each user in chronological order in which said message was accepted.

19. The method of claim 16, the method steps further comprising:
accepting, from said second user, at least one content interaction message related to one or more points of interest, wherein said points of interest are not the subject of a content interaction message generated by said first user.

20. The method of claim 16, the method steps further comprising:
accepting, from said first user, at least one content interaction response message related to one or more points of interest.
